(19) United States
(12) Patent Application Publication
(10) Pub. No.: US 2015/0089250 A1
(43) Pub. Date: Mar. 26, 2015

(54) Contention Prevention for Sequenced Power Up of Electronic Systems

(71) Applicant: Apple Inc., Cupertino, CA (US)

(72) Inventor: Greg M. Hess, Mountain View, CA (US)

(73) Assignee: Apple Inc., Cupertino, CA (US)

(21) Appl. No.: 14/036,749

(22) Filed: Sep. 25, 2013

(51) Int. Cl. G06F 1/26

(52) U.S. Cl. CPC G06F 1/263
USPC 713/300

(57) ABSTRACT

A method and apparatus for preventing contention during the sequenced power up of an electronic system is disclosed. In one embodiment, an apparatus includes first and second power domains configured to receive power from first and second power sources, respectively. During a power up sequence, the first power source is configured to provide power prior to the second power source. A power detection circuit is configured to detect the presence of power from both of the first and second power sources. If power has not been detected from the second power source, a signal provided to a clamping circuit is asserted. When the signal is asserted by the power detection circuit, the clamping circuit may inhibit the control signal received from the second power domain from being provided to a power switch in the first power domain.

### BACKGROUND

1. Technical Field

This disclosure relates to integrated circuits, and more particularly, to controlling logic signals during a sequenced power up of an electronic system having multiple power domains.

2. Description of the Related Art

Modern electronic systems (e.g., computer systems, wireless devices, etc.) and integrated circuits implemented therein often utilize multiple power sources, to provide power to different power domains. In particularly, certain types of circuitry may have different voltage and/or current requirements than other circuits. For example, input/output (I/O) circuits may require a first operating voltage, a memory subsystem may require a second operating voltage, while circuitry in a processor core might require a third operating voltage. Each of the first, second, and third operating voltages may be different from one another.

In systems and/or integrated circuits having multiple power domains, the corresponding power supplies may be powered on in a pre-determined sequence. Using the example above, the I/O circuits could be powered on first, followed by the circuitry in one or more processor cores, and followed finally by the memory subsystem. After all subsystems have been powered up, communications therebetween may commence.

### SUMMARY OF THE DISCLOSURE

A method and apparatus for preventing contention caused by cross-domain signals during the sequenced power up of an electronic system is disclosed. In one embodiment, an apparatus includes a first power domain coupled to receive power from a first power source and a second power domain coupled to receive power from a second power source. During a power up sequence, the first power source is configured to provide power prior to the second power source. A power detection circuit is configured to detect the presence of power from both of the first and second power sources. If power has not been detected from the second power source, the power detection circuit may assert an indication signal to a clamping circuit, such as a clamping level shifter. The clamping circuit may be configured to receive a control signal from the second power domain and provide a level shifted control signal to a power switch in the first power domain. When the power detection circuit asserts the indication signal, the level shifter may inhibit the control signal from being provided to the power switch.

The apparatus described herein may include a first power switch coupled between the first power source and a first virtual voltage node, and a second power switch coupled between the second power source and a second virtual voltage node. Moreover, circuitry in the second power domain may be configured to convey signals to circuitry in the first power domain. Among the signals conveyed from the second power domain into the first is a control signal provided to the level shifter, which outputs a level shifted version thereof to them first power switch. When the control signal is active, it may activate the first power switch, thereby electrically coupling the first virtual voltage node to the first power source. However, when the second power source has not yet provided power to the second power domain (during the power up sequence, when power has already been provided to the first power domain), the control signal may be in an indeterminate state. The level shifter receiving the control signal may be a clamping level shifter that includes an extra input, which is coupled to receive the indication signal from the power detection circuit. When the indication signal is asserted, the level shifter may drive its output to a pre-determined level that in turn inhibits the first power switch from being activated. In turn, circuitry in the first power domain coupled to receive power via the first virtual voltage node may remain powered off at least until the second power source is providing power. Accordingly, indeterminate signals conveyed to the second power domain from the first power domain are prevented from causing problems such as crowbar currents or contention issues.

Once power is provide by the second power source, the power detection circuit may de-assert the indication signal. The level shifter may then provide the control signal to the first power switch in a state corresponding to the state at which it was received from the first power domain. When the control signal is asserted to an active state, the first power switch may be activated. When power is provided from the second power source, the second power switch may also be activated, thereby allowing power to be provided to circuitry in the second power domain that is coupled to receive power via the second virtual voltage node. Thereafter, signals transferred between the power domains may be transferred in deterministic states.

### BRIEF DESCRIPTION OF THE DRAWINGS

Other aspects of the disclosure will become apparent upon reading the following detailed description and upon reference to the accompanying drawings which are now described as follows.

FIG. 1 is a block diagram of one embodiment of an integrated circuit (IC) having multiple power domains.

FIG. 2 is a schematic diagram of one embodiment of a clamping level shifter circuit.

FIG. 3 is a flow diagram of one embodiment of a method for preventing contentions during a sequenced power up of multiple power domains.

FIG. 4 is a block diagram of one embodiment of an exemplary system.

While the subject matter disclosed herein is susceptible to various modifications and alternative forms, specific embodiments thereof are shown by way of example in the drawings and will herein be described in detail. It should be understood, however, that the drawings and description thereto are not intended to be limiting to the particular form disclosed, but, on the contrary, is to cover all modifications, equivalents, and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION

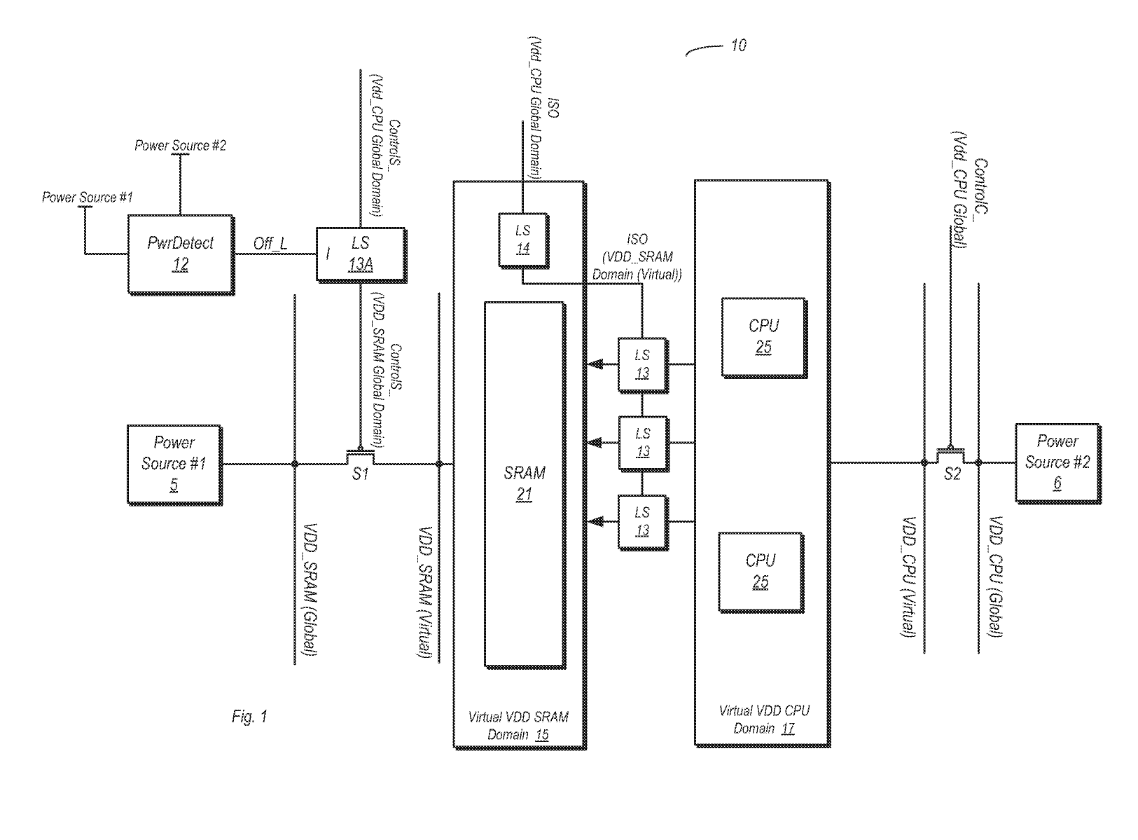

Turning now to FIG. 1, a block diagram of one embodiment of an integrated circuit (IC) is shown. In the embodiment shown, IC 10 is configured to receive power from at least two different power sources, which are shown here. It is noted that the system shown in FIG. 1 may be implemented in some embodiments using at least some discrete components rather than on an IC. For example, a computer system is possible and contemplated that implements several of the different components shown in FIG. 1 on different IC's or other circuits.

In the embodiment shown, power may be provided to various circuits in IC 10 via power source #1 and power source #2. In this particular embodiment, power source #1 may provide power to a first power domain, VDD_SRAM, while power source #2 may provide power to a second power domain, VDD_CPU

As defined herein, the term ‘power source’ may be any type of power supply or power circuitry used to deliver power to other circuits. For example, power sources #1 and #2 in the embodiment shown may be implemented as voltage regulators that are coupled to receive power from one or more external sources, such as a battery, another power supply, a wall outlet, etc. It is noted that power sources #1 and #2 may be implemented off-chip in some embodiments. In general, the term power source as used herein may be defined as any apparatus that provides power to a power domain of a system or integrated circuit as discussed herein.

In the embodiment shown, VDD_SRAM and VDD_CPU are global voltage nodes. A first power switch S1 is coupled between VDD_SRAM(Global) and a virtual voltage node, VDD_SRAM(Virtual). A second power switch S2 is coupled between VDD_CPU(Global) and VDD_CPU(Virtual). It is noted that for both global voltage nodes, additional virtual voltage nodes may be implemented, with corresponding power switches coupled therebetween.

As used herein, the term ‘global voltage node’ may be defined as a voltage node which is used to distribute power to a number of different circuits, and may also distribute power, via power switches, to one or more virtual voltage nodes. Generally speaking, a global voltage node may remain powered on any time the system in which it is implemented is active, even if some circuits that can receive power via that global voltage node may be idle. A virtual voltage node as defined herein may be a voltage node that is associated with a global voltage node and may receive power therefrom when one or more power switches coupled between the two are active. The circuitry coupled to the virtual voltage node may be power-gated (i.e., turned off) when idle. Although not shown in FIG. 1, IC 10 (or an equivalent system) may include a power management unit configured to determine when the circuitry coupled to a virtual voltage node is idle. When such a determination is made, the power switch(es) coupled between a virtual voltage node and its corresponding global voltage node may be opened, thereby removing power from the virtual voltage node and the circuitry coupled thereto. This may be used to save power in IC 10 (or an equivalent system), while also providing greater granularity in the ability to save power.

Virtual voltage node VDD_SRAM(Virtual) in the embodiment shown is coupled to provide power to the Virtual VDD_SRAM domain 15 (where SRAM is Static Random Access Memory). Virtual VDD_SRAM domain 15 is a power domain that includes an SRAM 21 configured store data. Virtual VDD_SRAM domain 15 also includes a level shifter 14, which will be discussed in further detail below, along with level shifters 13.

Virtual voltage node VDD_CPU(Virtual) in the embodiment shown is coupled to provide power to Virtual VDD_CPU domain 17. Virtual VDD_CPU domain 17 is a power domain that includes, in this particular embodiment, two instances of CPU (Central Processing Unit) 25. Although not shown, Virtual VDD_CPU domain 17 may include other circuitry, including circuitry used to facilitate communications between both instances of CPU 25.

Circuitry in Virtual VDD CPU domain 17 in the embodiment shown is coupled to send signals to circuitry in Virtual VDD SRAM domain 15. Among these signals may be control signals conveyed from either of CPU's 25 to SRAM 21. Since the operating voltages of the two power domains are different, level shifters 13 are implemented at the boundary. Three exemplary instances of level shifters 13 are shown here, although the exact number may vary from one embodiment to the next. Signals transferred from Virtual VDD CPU domain 17 may be level shifted to appropriate levels for receiving by circuitry in Virtual VDD SRAM domain 15.

Level shifters 13 in the embodiment shown are clamping level shifters. In addition to having an input for receiving the signal to be level shifted, each level shifter 13 also includes an isolation input. A signal provided via the isolation input may be used to cause an instance of level shifter 13 to provide a deterministic output signal when its corresponding input signal is indeterminate (e.g., during power up of the domain from which the input signal is received). In this example, various ones of the level shifters 13 are coupled to receive an isolation signal ‘ISO’, in the VDD_SRAM domain, from level shifter 14 (which receives a corresponding ISO signal in a global voltage domain). It is noted that in this particular embodiment, level shifter 14 is implemented as a standard level shifter, and thus does not include an isolation input.

Although not explicitly shown here, circuitry (e.g., SRAM 21) in Virtual VDD SRAM domain 15 is also configured to convey signals to circuitry (e.g., CPU's 25) in Virtual VDD CPU domain 17. Accordingly, additional level shifters may be implemented to facilitate signals conveyed from Virtual VDD SRAM domain 15 to Virtual VDD CPU domain 17. These additional level shifters may be implemented as clamping or standard level shifters, as desired.

Power switch S1 may be activated by a control signal, ControlS_, which may be received from level shifter 13A, which is another instance of level shifter 13 and may thus be similarly (or identically) configured. The input version of this signal for this instance of level shifter 13 is received from circuitry in the VDD_CPU global domain, while the output signal is provided to S1 in the VDD_SRAM global domain. The isolation signal ‘Off_L’ received on the ‘I’ input, is received by level shifter 13 from power detection circuit 12.

Power detection circuit 12 in the embodiment shown is coupled to receive and detect power from both power source #1 and power source #2. During a power up sequence for the embodiment of IC 10 shown in FIG. 1, power source #1 may be powered up before power source #2. Power detection circuit 12 in the embodiment shown is configured to assert the ‘Off_L’ signal when power from power source #2 has not been detected. Since the input version of ControlS_ is received from the CPU global domain, this signal may be indeterminate when power source #2 is not yet fully powered on. Similarly, signals send from the virtual VDD_CPU domain to the virtual VDD_SRAM domain may also be indeterminate. These indeterminate signals can cause undesirable operation, such as crowbar currents and/or contention issues. Accordingly, it may be desirable to prevent indeterminate signals from crossing from one power domain to another. In the embodiment of IC 10 shown herein, the preventing of indeterminate signals from the virtual VDD_CPU domain affecting operation of circuitry virtual VDD_SRAM domain may be prevented by the use of level shifter 13A.

When the off signal is asserted, the ControlS_ signal in the VDD_SRAM global domain may be driven high, thereby causing S1 to be held in an inactive state (i.e. off). When S1 is off, the virtual VDD_SRAM domain does not receive any power. Accordingly, SRAM 21 and level shifter 14 may both be powered off. When power is detected from power source #2, power detection circuit 12 may de-assert the off signal. Thereafter, the output of level shifter 13A may follow the input version of ControlS_. When the output version of ControlS_ is asserted (as a low in this embodiment), power switch S1 may be activated, thereby providing power to the circuitry in the virtual VDD_SRAM domain, including level shifter 14, the output side of level shifters 13, and SRAM 21. If the ISO signal is de-asserted subsequent to the powering on of power source #2, signals may be transferred from the virtual VDD_CPU domain to the virtual VDD_SRAM domain via level shifters 13. Otherwise, the outputs of those level shifters 13 are held to a predetermined state irrespective of the state of their respectively received input signals.

Accordingly, the use of level shifter 13A, and more particularly providing the Off_L signal to level shifter 13A, may prevent the previously mentioned undesirable operation during a power-up sequence in which power source #1 is powered up prior to power source #2. The undesirable operation may also be prevented when circuitry coupled to the virtual voltage nodes is powered on again after being power-gated (i.e. to be placed in a sleep mode).

Alternative embodiments of IC 10 are possible and contemplated wherein the OFF signal may be routed to the isolation inputs of level shifters 13 when no level shifter 13A is present. However, in the embodiment shown, the Off_L signal need only to be routed to a single level shifter, level shifter 13A, which may be easier.

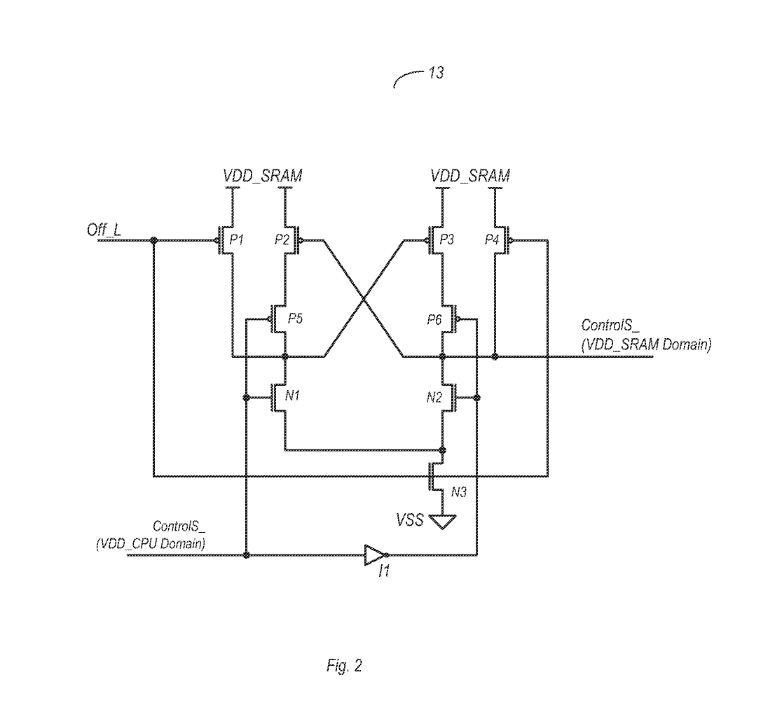

Turning now to FIG. 2, a schematic diagram of one embodiment of a level shifter 13 is shown. The embodiment shown in FIG. 2 may apply to any of level shifters 13 shown in FIG. 1, as well as to level shifter 13A, specifically. The discussion herein will focus on the operation of level shifter 13A as arranged in IC 10 of FIG. 1, although similar operation may be described for the other instances of level shifter 13 shown in FIG. 1, as well as for other clamping level shifters in general that may be implemented in IC 10.

It is noted that transistors designated here with a ‘P’ (e.g., P1, P2, etc.) are PMOS (p-channel metal oxide semiconductor) transistors. Transistors designated here with an ‘N’ (e.g., N1, N2) are NMOS (n-channel metal oxide semiconductor) transistors. Transistors P1, P2, P3, and P4 in the embodiment shown each include a drain terminal coupled to VDD_SRAM, and thus the output node ControlS_ of level shifter 13 is referenced thereto. The input node Control_S is referenced to the VDD_CPU domain. In the embodiments of FIG. 1 and FIG. 2, the operating voltage of the VDD_SRAM domain (and thus the global and virtual nodes associated therewith) is greater than the operating voltage of the VDD_CPU domain.

In the illustrated example, the input signal ControlS_ may be received (from the VDD_CPU domain) on the respective gate terminals of transistors P5, P6, N1, and N2. The circuit also includes transistors P2 and P3, which are arranged in a cross-coupled configuration, and transistors P1 and P4. The isolation signal, Off_L, may be received on the inputs of transistors P1 and P4, as well as by transistor N3. The isolation signal, Off_L, is an active low signal in this embodiment. When the Off_L signal is asserted low, transistors P1 and P4 are activated. When P4 is activated, the output node, ControlS_ to the VDD_SRAM domain, it held high. Additionally, transistor P2 is held in an off state when P4 is active. P3 is held in an off state when P1 is active. Furthermore, when the Off_L signal is asserted low, N3 remains off, thereby eliminating any pull-down path between the ControlS_ output node and ground.

When the Off_L signal is de-asserted (i.e. high in this embodiment), transistors P1 and P4 are turned off, while transistor N3 is turned on. Accordingly, the state of the output node ControlS_ follows the state of the corresponding input node Control_S. When the input node ControlS_ is high, transistor N1 is activated while transistor P5 is held inactive. Transistor P6, which is coupled to the output of inverter I1, is also activated responsive to the a high on the input ControlS_. When transistor N1 is active along with N3, the node coupled to the gate terminal of P3 is pulled low. Accordingly, P3 is also activated. With both P3 and P6 being active, the output node ControlS_ is pulled high. Referring back to FIG. 1, when the output node ControlS_ is high, power switch S1 remains off.

When the input node ControlS_ is low, transistor P5 is activated while transistor N1 is deactivated. The complement of the ControlS_ input node provided from the output node of inverter I1 causes the activation of transistor N2 while transistor P6 is held inactive. When N2 is active at the same time as N3, the output node ControlS_ is pulled low. Furthermore, P2 is activated when the ControlS_ output node is low since its gate terminal is coupled thereto. Since P5 is active and P2 are active at this point, the node coupled to the gate terminal of P3 is high, and thus P3 is turned off. Referring again back to FIG. 1, when the ControlS_ output is low, power switch S1 may be activated and thus power may be provided from the VDD_SRAM global voltage node to the VDD_SRAM virtual voltage node.

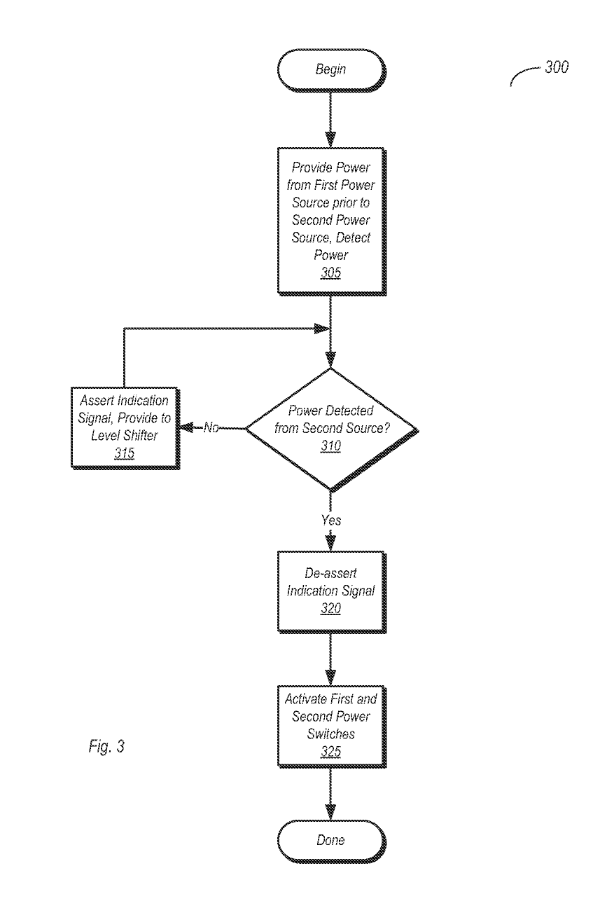

FIG. 3 is a flow diagram illustrating one embodiment of a method for preventing contentions during a sequenced power up of multiple power domains. Method 300 may be performed with the various apparatus embodiments discussed herein, including variations thereof that are not specifically mentioned. Furthermore, it is possible and contemplated that method 300 may be performed with other apparatus embodiments not discussed herein.

Method 300 begins with the powering up of a first power source prior to powering up of a second power source (block 305). In the apparatus embodiment of FIG. 1, this may entail powering up power source #1 prior to powering up power source #2. If power from the second power source (e.g., power source #2) has note been detected (block 310, No), then an indication signal (e.g., ‘Off_L’) is provided to a level shifter (block 315). The asserted indication causes the level shifter to output a predetermined state irrespective of the state of the input signal (which may be indeterminate). The method then repeats cycling between blocks 310 and 315 until power is detected from the second power source. When power is detected from the second source (block 310, yes), the power detection circuit de-asserts the indication signal (block 320). Following de-assertion of the indication signal, the level shifter may output a signal in accordance with its input signal. Subsequent to the de-assertion of the indication signal, both the first and second power switches (e.g., S1 and S2 of FIG. 1) may be activated, thereby providing power to both of the virtual voltage domains.

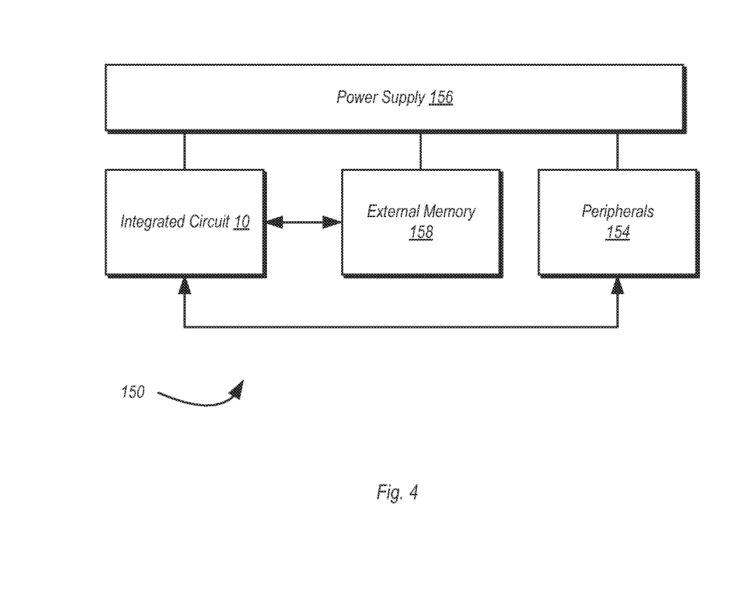

Turning next to FIG. 4, a block diagram of one embodiment of a system 150 is shown. In the illustrated embodiment, the system 150 includes at least one instance of the integrated circuit 10 coupled to external memory 158. The integrated circuit 10 is coupled to one or more peripherals 154 and the external memory 158. A power supply 156 is also provided which supplies the supply voltages to the integrated circuit 10 as well as one or more supply voltages to the memory 158 and/or the peripherals 154. In some embodiments, more than one instance of the integrated circuit 10 may be included (and more than one external memory 158 may be included as well).

The peripherals 154 may include any desired circuitry, depending on the type of system 150. For example, in one embodiment, the system 150 may be a mobile device (e.g. personal digital assistant (PDA), smart phone, etc.) and the peripherals 154 may include devices for various types of wireless communication, such as WiFi, Bluetooth, cellular, global positioning system, etc. The peripherals 154 may also include additional storage, including RAM storage, solid-state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, tablet, etc.).

The external memory 158 may include any type of memory. For example, the external memory 158 may be SRAM, dynamic RAM (DRAM) such as synchronous DRAM (SDRAM), double data rate (DDR, DDR2, DDR3, LPDDR1, LPDDR2, etc.) SDRAM, RAMBUS DRAM, etc. The external memory 158 may include one or more memory modules to which the memory devices are mounted, such as single inline memory modules (SIMMs), dual inline memory modules (DIMMs), etc.

Numerous variations and modifications will become apparent to those skilled in the art once the above disclosure is fully appreciated. It is intended that the following claims be interpreted to embrace all such variations and modifications.

What is claimed is:

1. An integrated circuit comprising:
a power detection circuit configured to detect power from a first power source associated with a first power domain, and further configured to detect power from a second power source associated with a second power domain, wherein, during power-up of the integrated circuit, the first power source is configured to provide power to the first power domain prior to the second power source providing power to the second power domain; and
a level shifter coupled to receive a control signal from the second power domain and configured to provide a level shifted version of the control signal to a first power switch in the first power domain, wherein the power detection circuit is configured to cause the level shifter to inhibit activation of the first power switch until power is detected from the second power source.

2. The integrated circuit as recited in claim 1, wherein the first power switch is coupled between the first power source and a first virtual voltage node, and wherein the integrated circuit further includes a second power switch coupled between the second power source and a second virtual voltage node.

3. The integrated circuit as recited in claim 1, wherein the level shifter is coupled to receive an indication from the power detection circuit that power has not been detected from the power source, and configured to provide a deterministic output signal responsive to receiving the indication from the power detection circuit.

4. The integrated circuit as recited in claim 3, wherein the power detection circuit is configured to discontinue providing the indication to the level shifter responsive to detecting power in the second domain.

5. The integrated circuit as recited in claim 4, wherein the level shifter is configured to provide the level shifted version of the control signal to the first power switch at a logic value corresponding to which the control signal is received responsive to the power detection circuit discontinuing providing the indication.

6. The integrated circuit as recited in claim 2, wherein the second power switch is configured to be activated responsive to power being provided by the second power source.

7. The integrated circuit as recited in claim 1, wherein the level shifter is configured to cause activation of the first power switch responsive to the power detection unit indicating that power has been detected from the second power source.

8. The integrated circuit as recited in claim 1, wherein the level shifter is a clamping level shifter.

9. A method comprising:
detecting power being provided to a first power domain using a power detection circuit;
detecting that power is not being provided to a second power domain using the power detection circuit;
inhibiting activation of a first power switch coupled between a first power source and a first virtual voltage node responsive to detecting that power is not being provided to the second power domain.

10. The method as recited in claim 9, wherein inhibiting activation of the first power switch comprises:
providing a signal from the power detection circuit to a level shifter, the signal indicating, when asserted, that power is not being provided to the second power domain; and
the level shifter providing an output signal at a deterministic value to the first power switch responsive to receiving the signal from the power detection circuit irrespective of a state of an input signal received by the level shifter from circuitry in the second power domain.

11. The method as recited in claim 10, further comprising:
detecting power being provided from the second power source;
discontinuing inhibiting activation of the first power switch responsive to detecting power being provided from the second power source.

12. The method as recited in claim 11, wherein discontinuing inhibiting activation of the first power switch comprises:
the power detection circuit de-asserting the signal provided to the level shifter; and
the level shifter providing the output signal at a state corresponding to a state of the input signal received from circuitry in the second power domain.

13. The method as recited in claim 10, further comprising:
activating the first power switch responsive to the power detection circuit detecting power being provided to the second power domain; and
activating a second power switch responsive to power being provided to the second power domain, wherein the second power switch is coupled between a second power source and a second virtual voltage node.

14. The method as recited in claim 13, further comprising conveying control signals from circuitry in the second power domain to circuitry in the first power domain subsequent to activation of the first power switch and the second power switch.

15. The method as recited in claim 14, further comprising level shifting the control signals from an operating voltage of the second power domain to an operating voltage of the first power domain.

16. A system comprising:
a first power source configured to provide power to circuitry in a first power domain;
a second power source configured to provide power to circuitry in a second power domain, wherein, during a system power on routine, the first power source is configured to be activated prior to activation of the second power source;
a power detection circuit configured to detect power from each of the first and second power sources and configured to assert an indication signal when power from the second power source is not detected; and
a level shifter configured to provide an output signal to a first power switch coupled between the first power source and a first virtual voltage node, wherein the power detection circuit is configured to cause the level shifter to inhibit activation of the first power switch by asserting the indication signal.

17. The system as recited in claim 16, wherein the level shifter is configured to receive a control signal from circuitry in the second power domain and is further configured to, when the indication signal is de-asserted, provide as the output signal a level-shifted version of a control signal received from circuitry in the first power domain.

18. The system as recited in claim 16, wherein the power detection circuit is configured to de-assert the indication signal when power from the second power source is detected.

19. The system as recited in claim 16, wherein the level shifter is configured to cause activation of the first power switch responsive to the power detection circuit de-asserting the indication signal and receiving an asserted control signal from circuitry in the first power domain, wherein the system further comprises a second power switch coupled between the second power source and a second virtual voltage node, wherein the second power switch is configured to be activated responsive to the second power source providing power to the second power domain.

20. The system as recited in claim 16, wherein the level shifter is a clamping level shifter.
